(19) United States
(12) Patent Application Publication
(10) Pub. No.: US 2013/0107552 A1
(43) Pub. Date: May 2, 2013

(54) SPOT LAMP UNIT, HEADLIGHT SYSTEM WITH SPOT LAMP UNIT, AND FRONT LIGHTING METHOD USING THE SAME

(71) Applicants: Byoungsuk Ahn, Suwon-si (KR); Youngsub Oh, Suwon-si (KR); Inheum Park, Seongnam-si (KR); Myunggug Bang, Yongin-si (KR)

(72) Inventors: Byoungsuk Ahn, Suwon-si (KR); Youngsub Oh, Suwon-si (KR); Inheum Park, Seongnam-si (KR); Myunggug Bang, Yongin-si (KR)

(73) Assignees: Hyundai Mobis Co., Ltd., Seoul (KR); Hyundai Motor Company, Seoul (KR)

(21) Appl. No.: 13/556,007

(22) Filed: Jul. 23, 2012

(30) Foreign Application Priority Data
Oct. 31, 2011 (KR) 10-2011-0112100

(51) Int. Cl. B60Q 1/08; F21V 5/04

(52) U.S. Cl. 362/465; 362/520

(57) ABSTRACT

A spot lamp unit includes an LED lamp mounted with LEDs taking charge of and lighting up front divided lighting areas, a heat sink provided on a rear surface of the LED lamp, and a lens provided in the front of the LED lamp to focus or diffuse light emitted from the LED lamp, and the headlight system capable of spot-lighting includes an infrared radiator, a camera photographing infrared rays reflected on a lighting target, an image processing unit reading the lighting target from the photographed image and judges whether the lighting target is dangerous, and a lamp driving unit driving the spot lamp unit to turn on the LED lamp lighting up an area where the lighting target is positioned.

### CROSS-REFERENCE TO RELATED APPLICATIONS

The present application claims priority of Korean Patent Application Number 10-2011-0112100 filed Oct. 31, 2011, the entire contents of which application is incorporated herein for all purposes by this reference.

### BACKGROUND OF INVENTION

1. Field of Invention

The present invention relates to a spot lamp unit, a headlight system with the spot lamp unit, and a front lighting method using the same, and more particularly, to a spot lamp unit, a headlight system with the spot lamp unit, and a front lighting method using the same that can additionally spot-light an area where a pedestrian exists by using the spot lighting unit together with front lighting through a headlamp by recognizing the pedestrian during night driving.

2. Description of Related Art

A headlight constituted by a plurality of headlamps, as means for ensuring a front visual field at night is provided in the front of a vehicle and manually or automatically turned on during night driving, tunnel driving, or rainy days to ensure the front visual field of the driver.

However, since the headlight of the present vehicle uses a scheme in which a front wide range is lighted up with the headlight, the headlight cannot sufficiently ensure the front visual field.

Since the vehicular headlight cannot sufficiently light up the front, it is difficult to ensure the front visual field, and as a result, in particular, the driver little finds a pedestrian or a wild animal at night, which may lead to an accident. That is, since the wide front area is lighted up by using the headlight, the front pedestrian or wile animal cannot be properly determined, and as a result, this may lead to a pedestrian accident or road kill.

Meanwhile, in order to solve the problem, there is also a technology of observing the front by installing an infrared camera in the front of the vehicle and by using an instrumental panel or an additional installed monitor. However, this technology deteriorates driver's observation power because the driver should observe the monitor as well as the front as the front of the vehicle is photographed by using the infrared camera installed in the front of the vehicle and thereafter, the photographed front can be verified only through the additional monitor.

In order to perform infrared-photographing of the front and display the corresponding front through the monitor, the headlight of a related art has a night vision apparatus including an infrared projector enabling selective infrared-ray irradiation by using a light source of the headlight is disclosed.

The information disclosed in this Background of the Invention section is only for enhancement of understanding of the general background of the invention and should not be taken as an acknowledgement or any form of suggestion that this information forms the prior art already known to a person skilled in the art.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a spot lamp unit configured to additionally and concentratively light up a pedestrian or a wild animal by recognizing the pedestrian or wild animal when the pedestrian or wild animal emerges as well as a wide-range front, which is installed in a headlamp lighting up the front.

Various aspects of the present invention have been made in an effort to provide a headlight system with the spot lamp unit.

Various aspects of the present invention have been made in an effort to provide a front lighting method using the headlight system with the spot lamp unit.

Various aspects of the present invention provide for a spot lamp unit, including an LED lamp mounted in a headlight of a vehicle or mounted on a front end of the vehicle and having a plurality of LEDs dividing a front lighting area and lighting up the respective divided areas, a heat sink installed on a rear surface of the LED lamp in order to dissipate heat generated from the LED lamp to the outside, and a lens provided in the front of the LED lamp to focus or diffuse light emitted from the LED lamp.

A distance between the LED lamp and the lens may be variable.

The spot lamp unit may further include an actuator of which a front end is advanceable or retreatable, and a lamp holder fixed to the front end of the actuator and mounted with the LED lamp and the heat sink and the actuator may vary the distance between the LED lamp and the lens by making the LED lamp advance or retreat to concentratively shine the light emitted from the LED lamp unit.

The lens may be an aspheric lens.

Various aspects of the present invention provide for a headlight system capable of spot-lighting, including an infrared-ray radiator radiating infrared rays to the front of a vehicle, a camera photographing an infrared ray reflected on a lighting target among the infrared rays radiated therefrom, an image processing unit reading the lighting target from an image photographed by the camera and judging whether the lighting target is dangerous, a spot lamp unit including an LED lamp mounted with a plurality of LEDs dividing a front lighting area of a vehicle to light up the respective areas, and a lamp driving unit driving the spot lamp unit to turn on the LED lamp lighting up an area where the lighting target is positioned when the image processing unit judges that the lighting target is dangerous.

Various aspects of the present invention provide for a front lighting method using a headlight capable of spot-lighting, including a headlight turning-on process of turning on a headlight, an image acquiring process of radiating infrared rays in a driving direction of a vehicle in an infrared radiator provided in the vehicle, receiving an infrared ray on a lighting target and storing the received infrared ray as a video image, a lighting target detecting process of recognizing the lighting target from the image acquired in the image acquiring process, a lighting target danger judging process of judging whether the detected lighting target is dangerous when the lighting target is detected in the lighting target detecting process, and a spot lamp driving process of turning on a spot lamp to light up the lighting target when it is judged that the lighting target is dangerous in the lighting target danger judging process.

The method may further include a headlight turn-off judging process of judging whether the headlight is turned off after the spot lamp driving process is performed.

When it is judged that the headlight is not turned off in the headlight turn-off judging process, the process may return to the image acquiring process.

When it is judged that the lighting target is not dangerous in the lighting target danger judging process, the headlight turn-off judging process may be performed.

According to various aspects of the present invention, a spot lamp unit, a headlight system with the spot lamp unit, and a front lighting method, by using the spot lamp unit recognizing and lighting up a pedestrian or a wild animal as well as a headlamp lighting up the front widely, the pedestrian or wild animal is concentratively lighted up to allow a driver to recognize the pedestrian or wild animal through eyesight, thereby improving night driving stability.

Further, the spot lamp unit is used as a headlight in the daytime by changing a focus distance to improve driving stability and assists an upper beam during general night driving to light up the front.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram of an exemplary headlight system with a spot lamp unit according to the present invention.

FIG. 2 is an exploded perspective view of an exemplary headlight with the spot lamp unit according to the present invention.

FIG. 3A is a perspective view of an LED lamp in an exemplary spot lamp unit and

FIG. 3B is a photograph produced by photographing a state in which an LED is turned on in the LED lamp.

FIG. 4 is a diagram showing a beam distribution in spot lighting using an exemplary spot lamp unit according to the present invention.

FIGS. 5A and 5B are photographs produced by photographing a state in which the front is lighted up by using an exemplary headlight system with the spot lamp unit according to the present invention, in which FIG. 5A shows a photograph produced by photographing a state in which a front object is lighted up by using an exemplary headlight system with the spot lamp unit according to the present invention and FIG. 5B is a photograph produced by photographing a state in which a pedestrian is lighted up during driving a road at night by using an exemplary headlight system with the spot lamp unit according to the present invention.

FIG. 6 is a diagram showing a beam distribution during turning on a daytime running light by using an exemplary spot lamp unit according to the present invention.

FIG. 7 is a diagram showing a beam distribution in lighting assisting an upper beam by using an exemplary spot lamp unit according to the present invention.

FIG. 8 is a flowchart showing a front lighting method using an exemplary headlight system with the spot lamp unit according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

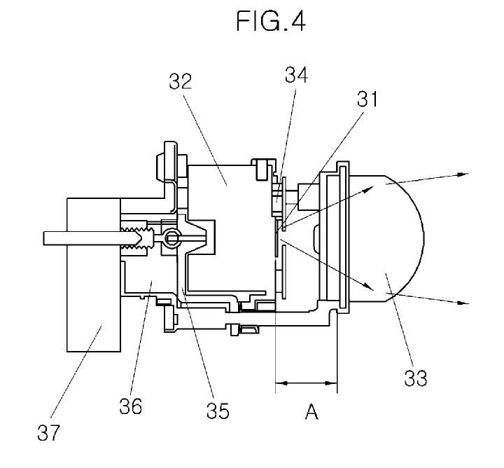

First, referring to FIG. 4, the spot lamp unit according to various embodiments of the present invention will be described below.

A spot lamp unit 30 according to various embodiments of the present invention includes an LED lamp 31 emitting light when power is applied, a heat sink 32 cooling LED lamp 31, and a lens 33 provided in the front of LED lamp 31 to control an irradiation direction of the light emitted from LED lamp 31. Spot lamp unit 30 is installed in a headlight of a vehicle or installed in the front of the vehicle apart from the headlight.

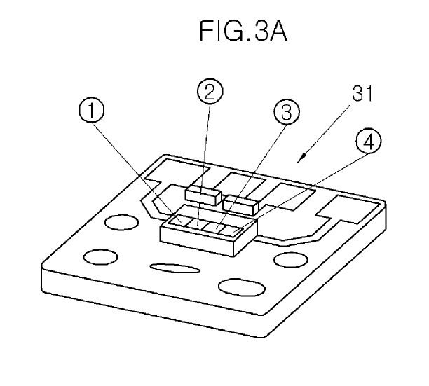

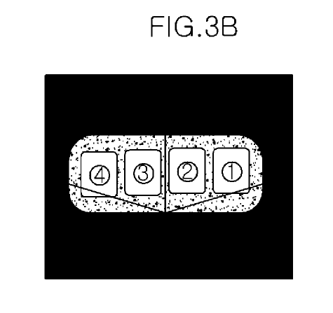

LED lamp 31 is provided on a PCB with an LED in a chipset form and the LED is installed in multiple according to areas dividing the front of the vehicle. That is, when a left side or a right side of the front of the vehicle is divided into four areas and one area among them is selected to be spot-lighted, the LED in LED lamp 31 is provided multiples of 4 as shown in FIGS. 3A and 3B. For example, when LED lamp 31 of FIG. 3A is constituted by LED \textcircled{1} to \textcircled{4}, as shown in \textcircled{1} to \textcircled{4} of FIG. 3B, the LED taking charge of a corresponding area among four LEDs is selected to be emitted, thereby achieving spot-lighting.

Heat sink 32 is attached to a rear surface of LED lamp 31 to dissipate heat generated by the lighting of LED lamp 31. A heat dissipating fin that protrudes in an opposite direction to the irradiation direction of LED lamp 31 is formed on the rear surface of LED lamp 31 to dissipate the heat generated by the turn-on of LED lamp 31.

LED lamp 31 and heat sink 32 are installed in and fixed to an internal space between a housing 11 and a cover 13 of headlight 10 of the vehicle by using a lamp bracket 36.

Lens 33 is positioned in the front of LED lamp 31 to control an irradiation range of the light emitted from LED lamp 31. That is, the light emitted from LED lamp 31 is diffused or focused through the lens and in particular, the lens focuses the light of LED lamp 31 when a lighting target is concentratively lighted (spot-lighted). Since spot lamp unit 30 according to various embodiments of the present invention has a primary goal to concentratively light a pedestrian or a wild animal at night, the light emitted from LED lamp 31 is focused to be concentrated on the lighting target and since spot lamp unit 30 has a sub-goal to be used as a daytime running light in the daytime or assist an upper beam at night, the light emitted for each use purpose is focused or distributed.

In this case, lens 33 adopts an aspherical lens having an excellent optical characteristic.

Meanwhile, LED lamp 31 may spot-light the lighting target such as the pedestrian or wild animal during night driving, but a frequency at which the lighting target is spot-lighted at night is low, and as a result, a distance between LED lamp 31 and lens 33 may be configured to be variable so that LED lamp 31 can be used as the daytime running light or assist the upper beam at night for easy distinction from other vehicles.

For example, as shown in FIG. 4, spot lamp unit 30 includes an actuator 37 fixed to lamp bracket 36 and a lamp holder 35 connected to a front end of actuator 37 through a pivot 38 and mounted with LED lamp 31 and heat sink 32. LED lamp 31 advances or retreats on a guide (reference numeral is not given) of lamp holder 35 by extension of actuator 37 to vary the distance between LED lamp 31 and lens 33.

That is, when the front end of actuator 37 advances, LED lamp 31 advances while lamp holder 35 mounted with LED lamp 31 advances. On the contrary, when the front of actuator 37 retreats, LED lamp 31 retreats, and as a result, the light emitted from LED lamp 31 is focused or distributed.

Meanwhile, although not shown in the figure, lens 33 may advance or retreat with respect to LED lamp 31 and both LED lamp 31 and lens 33 have a movable structure, thereby varying the distance between LED lamp 31 and lens 33 to concentrate or distribute the light irradiated from LED lamp 31.

Therefore, spot lamp unit 30 collects the light emitted from LED lamp 31 by using lens 33 as shown in FIG. 4 to spot-light the front lighting target.

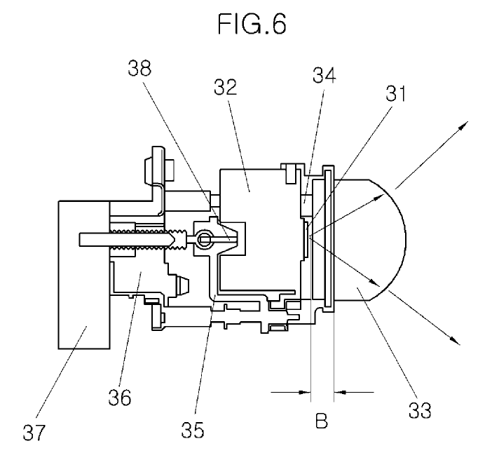

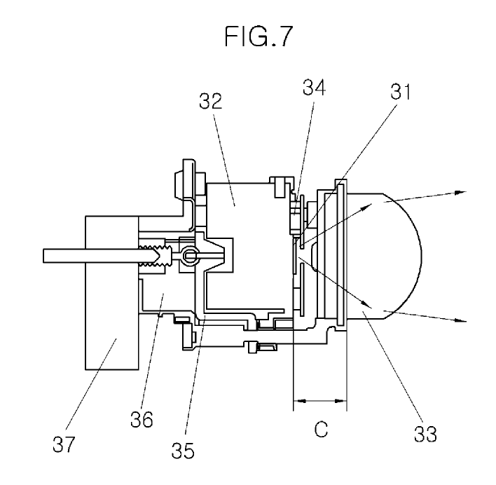

In the case of using the headlight in the daytime or assisting the upper beam at night, the light emitted from LED lamp 31 may be controlled by varying the distance between LED lamp 31 and lens 33 as shown in FIGS. 6 and 7. That is, as shown in FIGS. 4, 6, and 7, the distance between LED lamp 31 and lens 33 is varied to A, B, and C to focus or distribute the light emitted from LED lamp 31. In the case of the distance between LED lamp 31 and lens 33, distance C between LED lamp 31 used to assist the upper beam at night and lens 33 is shorter than distance A between LED lamp 31 lighting the front and lens 33 and distance B between LED lamp 31 and lens 33 when LED lamp 31 is used as the daytime running light may be shortest and the distance may vary depending on refractivity of lens 33.

In the spot-lighting, only a predetermined LED of LED lamp 31 is turned on to shine the spot-lighting area, but when the daytime running light or a night upper beam auxiliary lamp is used, a plurality of LEDs may be turned on.

Spot lamp unit 30 is provided in headlight 10 with a high/low beam unit 12 called the headlight and the upper beam, such that the front may be lighted through high/low beam unit 12 during general driving and spot lamp unit 30 may be actuated when the spot-lighting is required.

In the headlight system capable of spot-lighting according to various embodiments of the present invention, spot-lamp unit 30 is provided in headlight 10 and the vehicle recognizes a front spot-lighting target during driving to turn on the spot-lighting unit.

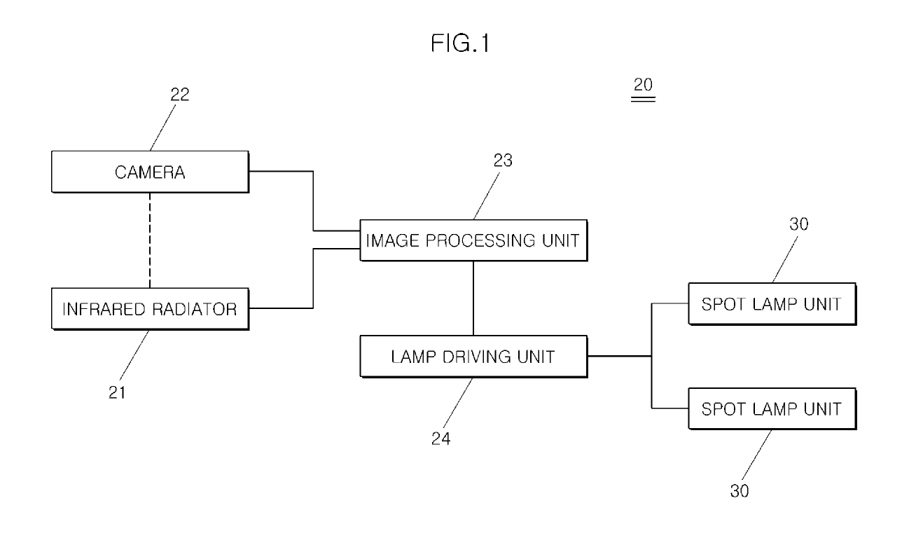

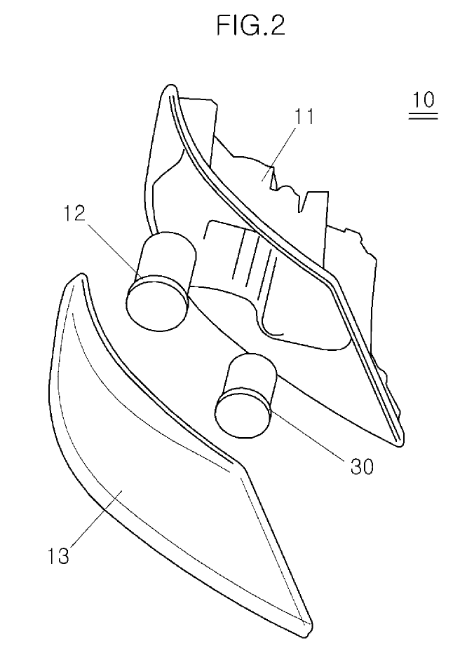

The headlight system capable of spot-lighting includes an infrared-ray radiator 21 radiating infrared ray, a camera 22 infrared-photographing the front, an image processing unit 23 reading the lighting target from an image photographed by camera 22, a spot lamp unit 30 dividing the front into a plurality of areas to selectively light the areas, and a lamp driving unit actuating spot lamp unit 30 to spot-light the spot-lighting target as shown in FIG. 1.

Infrared radiator 21 is positioned in the front of the vehicle to continuously radiate infrared rays to a driving direction of the vehicle. Since an object cannot be identified by visible rays at night, the object should be identified through the infrared rays, and as a result, the infrared rays should be radiated to the front of the vehicle by using infrared radiator 21.

Camera 22 photographs an image in which the infrared rays radiated through infrared radiator 21 are reflected on the lighting target. The infrared rays radiated to the front of the vehicle from infrared radiator 21 are reflected on the lighting target and photographed by camera 22 to acquire a front state of the vehicle which is driven as an infrared image.

Image processing unit 23 processes the image acquired by camera 22, identifies the lighting target in the processed image, and judges whether the identified lighting target is dangerous. Image processing unit 23 identifies the lighting target in the photographed image through imaging processing of pre-processing the image acquired through camera 22.

Meanwhile, since the process of identifying the lighting target in the photographed image is the process of identifying the image through general image processing, a detailed description thereof will be omitted.

Image processing unit 23 judges whether the lighting target is dangerous when the lighting target is identified as described above. That is, even though the lighting target is identified, if the lighting target is not in a dangerous state like a case in which the lighting target is largely separated from the driving direction of the vehicle, the lighting target needs not to be lighted, and as a result, image processing unit 23 identifies the lighting target through the image and thereafter, also judges whether the lighting target is dangerous. For example, when the lighting target is in the driving direction of the vehicle or adjacent to the driving direction of the vehicle, a case in which the lighting target accesses the driving direction of the vehicle may be a reference to recognize that the lighting target is in the dangerous state.

Spot lamp unit 30 includes a plurality of LED lamps 31 that divides the front to spot-light the divided front and when the front of the vehicle is divided into a plurality of areas, each LED lamp 31 takes charge of each area and lights the corresponding area.

Lamp driving unit 24 turns on the LED of LED lamp 31 taking charge of the lighting target in spot lamp unit 30 when image processing unit 23 judges that the lighting target is dangerous. Lamp driving unit 24 is connected to image processing unit 23 to control power to be applied to corresponding LED lamp 31 of spot lamp unit 30 so as to light up a lighting target area transferred as a dangerous situation (a situation in which lighting is required) from image processing unit 23.

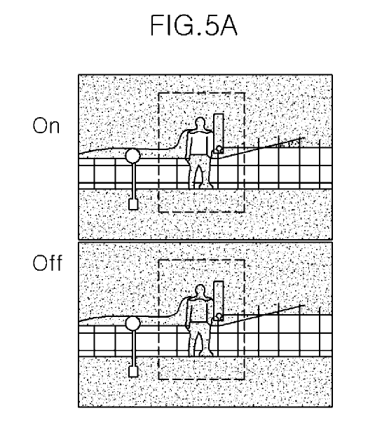

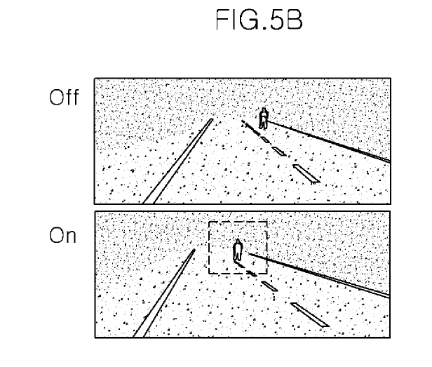

By the headlight system capable of spot-lighting according to various embodiments of the present invention, the front lighting target may be spot-lighted as shown in FIGS. 5A and 5B. FIG. 5A shows a test state. When the spot-lighting is turned on as shown in an upper part of FIG. 5A, the lighting target can be easily recognized as shown by a rectangular dotted line. Further, as shown in FIG. 5B, even when the lighting target is spot-lighted (On) during night driving, the driver can easily recognize the lighting target as shown in by the rectangular dotted line in the figure.

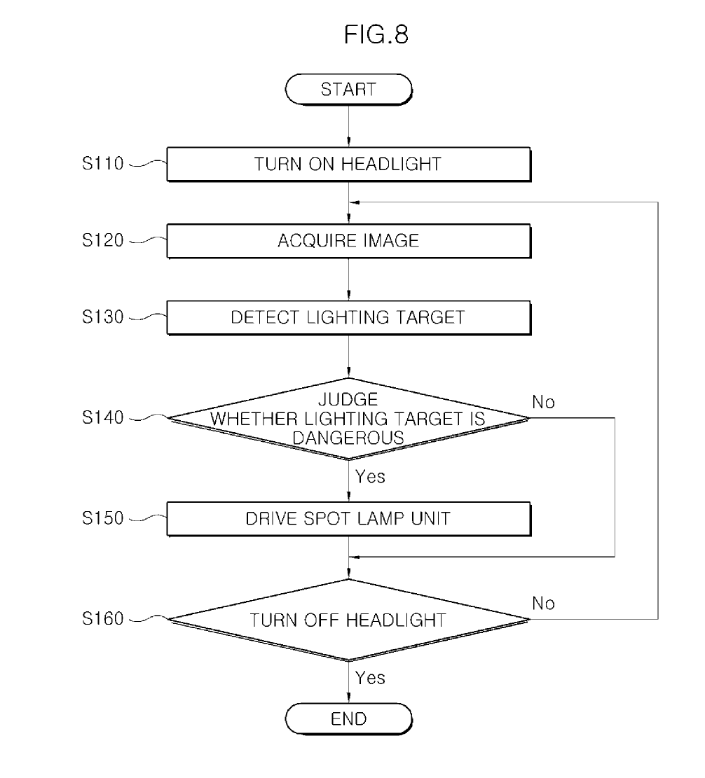

Meanwhile, a front lighting method using the headlight system with the spot lamp unit according various embodiments of the present invention will be described with reference to FIG. 8.

The front lighting method according to various embodiments of the present invention includes a headlight turning-on process S110 of turning on the headlight of the vehicle, an image acquiring process (S120) of photographing the front by using the headlight capable of spot-lighting and using infrared camera 22, a lighting target detecting process (S130) of recognizing the lighting target from the image acquired in the image acquiring process (S120), a lighting target danger judging process (S140) of judging whether the lighting target is dangerous in the image photographed in the lighting target detecting process (S130), and a spot lamp driving process (S150) of turning on spot lamp unit 30 taking charge of the lighting target when it is judged that the lighting target is dangerous in the lighting target danger judging process (S140).

In the headlight turning-on process (S110), the headlight provided in the front of the vehicle is manually or automatically turned on. The headlight provided in the front of the vehicle is automatically turned on by the driver or automatically turned on when outside illumination decreases to predetermined illumination or less. In order to spot-light a predetermined area such as a pedestrian or a wild animal, the headlight is turned on to primarily widely light up the front.

In the image acquiring process (S120), a front state of the driving vehicle is photographed as the image to ensure the front state as image data. The infrared rays are radiated to the front of the vehicle through infrared radiator 21 provided in the front of the vehicle. The radiated infrared rays are reflected on the lighting target and the infrared image is photographed by camera 22 to acquire the image for the front state of the vehicle.

In the lighting target detecting process (S130), the lighting target is detected from the acquired image. The acquired image is read in the image processing unit to detect the lighting target in the acquired image. The image processing unit first pre-processes the acquired image to be advantageous for reading the lighting target through correction, remapping, and the like. The image processing unit detects the lighting target in the pre-processed image based on brightness, a shape, and the like.

In the lighting target danger judging process (S140), it is judged whether the lighting target detected in the lighting target detecting process (S130) is dangerous. That is, image processing unit 23 judges whether the lighting target is dangerous by judging whether the lighting target is positioned in the driving direction of the vehicle or in an area adjacent to the driving direction and whether the lighting target moves to be close to the driving direction of the vehicle or the vehicle drives toward the lighting target.

If it is judged that the lighting target is dangerous in the lighting target danger judging process (S140), the LED lamp taking charging of the area where the lighting target is positioned is turned on in spot lamp unit 30. In spot lamp driving process (S150), since the plurality of LED lamps divide the front area of the vehicle and take charge of and light up the respective areas in spot lamp unit 30 as described above, the LED lamp taking charge of the area where the lighting target which is judged to be dangerous is positioned is turned on. While the headlight widely lights up the front of the vehicle for night driving, the LED lamp additionally lights up the area where the lighting target is positioned, and as a result, the driver easily recognizes the position of the lighting target to prevent an accident.

After spot lamp driving process (S150) is performed, a headlight turn-off judging process S160 of judging whether headlight 10 of the vehicle is turned on is performed. In the image acquiring process (S120) to the spot lamp driving process (S150), since the lighting target such as the pedestrian or wild animal is additionally lighted up while headlight 10 of the vehicle is turned on, the image acquiring process (S120) to the spot lamp driving process (S150) are performed only while headlight 10 is turned. Therefore, after the spot lamp driving process (S150) is performed, it is checked whether headlight 10 is turned off and when the headlight is not turned off, the process returns to the image acquiring process (S120) and when the headlight is turned off, all of the processes end.

For convenience in explanation and accurate definition in the appended claims, the terms upper, front or rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A spot lamp unit, comprising:
an LED lamp mounted on a front end of the vehicle and having a plurality of LEDs dividing a front lighting area and lighting up the respective divided areas;
a heat sink installed on a rear surface of the LED lamp in order to dissipate heat generated from the LED lamp to atmosphere; and
a lens provided in the front of the LED lamp to focus or diffuse light emitted from the LED lamp.

2. The spot lamp unit as defined in claim 1, wherein the LED lamp is mounted in a headlight of the vehicle.

3. The spot lamp unit as defined in claim 1, wherein a distance between the LED lamp and the lens is variable.

4. The spot lamp unit as defined in claim 2, further comprising:
an actuator of which a front end is advanceable or retreatable; and
a lamp holder fixed to the front end of the actuator and mounted with the LED lamp and the heat sink,
wherein the actuator varies the distance between the LED lamp and the lens by making the LED lamp advance or retreat to concentratively shine the light emitted from the LED lamp unit.

5. The spot lamp unit as defined in claim 1, wherein the lens is an aspheric lens.

6. A headlight system capable of spot-lighting, comprising:
an infrared-ray radiator radiating infrared rays to a front of a vehicle;
a camera photographing an infrared ray reflected on a lighting target among the infrared rays radiated therefrom;
an image processing unit reading the lighting target from an image photographed by the camera and judging whether the lighting target is dangerous;
a spot lamp unit including an LED lamp mounted with a plurality of LEDs dividing a front lighting area of a vehicle to light up the respective areas; and
a lamp driving unit driving the spot lamp unit to turn on the LED lamp lighting up an area where the lighting target is positioned when the image processing unit judges that the lighting target is dangerous.

7. A front lighting method using a headlight capable of spot-lighting, comprising:
a headlight turning-on process of turning on a headlight;
an image acquiring process of radiating infrared rays in a driving direction of a vehicle in an infrared radiator provided in the vehicle and receiving an infrared ray on a lighting target and storing the received infrared ray as a video image;
a lighting target detecting process of recognizing the lighting target from the image acquired in the image acquiring process;
a lighting target danger judging process of judging whether the detected lighting target is dangerous when the lighting target is detected in the lighting target detecting process; and
a spot lamp driving process of turning on a spot lamp to light up the lighting target when it is judged that the lighting target is dangerous in the lighting target danger judging process.

8. The front lighting method using a headlight capable of spot-lighting as defined in claim 7, further comprising:
a headlight turn-off judging process of judging whether the headlight is turned off after the spot lamp driving process is performed.

9. The front lighting method using a headlight capable of spot-lighting as defined in claim 8, wherein when it is judged that the headlight is not turned off in the headlight turn-off judging process, the process returns to the image acquiring process.

10. The front lighting method using a headlight capable of spot-lighting as defined in claim 9, wherein when it is judged that the lighting target is not dangerous in the lighting target danger judging process, the headlight turn-off judging process is performed.
